(19) United States
(12) Patent Application Publication
(10) Pub. No.: US 2026/0313489 A1
(43) Pub. Date: Oct. 8, 2026

(54) CELL CHANGE PROCEDURE IN A HYBRID TERRESTRIAL NETWORK-NON-TERRESTRIAL NETWORK (TN-NTN)

(71) Applicant: Telefonaktiebolaget LM Ericsson (publ), Stockholm (SE)

(72) Inventors: Muhammad Ali KAZMI, Reston, VA (US); Ming LI, Stockholm (SE); Ignacio Javier PASCUAL PELAYO, Stockholm (SE)

(21) Appl. No.: 19/483,121

(22) PCT Filed: May 13, 2024
(86) PCT No.: PCT/EP2024/063087

§ 371 Date: Nov. 10, 2025

Related U.S. Application Data
(60) Provisional application No. 63/501,729, filed on May 12, 2023.

(51) Int. Cl. H04W 36/00; H04W 36/14; H04W 88/06

(52) U.S. Cl. CPC H04W 36/00835; H04W 36/0058; H04W 36/0072; H04W 36/14; H04W 88/06

(57) ABSTRACT

A method, system and apparatus for performing a cell change procedure in a hybrid terrestrial network-non terrestrial network (TN-NTN) are disclosed. According to one aspect, a method in a user equipment (UE) includes determining a qualification status of at least a first cell of a first TN node and a second cell of a first NTN node. The method includes selecting a target cell for a cell change, the target cell being one of a qualified first cell of the first TN node and a qualified second cell of the first NTN node, the target cell being selected based at least in part on at least one of: a low activity multicarrier, LAM, measurement capability of the UE; a registration area of a candidate target cell; and a state of a global navigation satellite system, GNSS, receiver of the user equipment. The method also includes performing the cell change to the selected target cell.

### TECHNICAL FIELD

The present disclosure relates to wireless communications, and in particular, to performing a cell change procedure in a hybrid terrestrial network-non terrestrial network (TN-NTN).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and user equipments (UEs), as well as communication between network nodes and between UEs. The 3GPP is also developing standards for Sixth Generation (6G) wireless communication networks.

### Non-Terrestrial Network (NTN)

A satellite network or satellite based mobile network is interchangeably called a non-terrestrial network (NTN). A satellite within a NTN may be called a NTN node, NTN satellite or simply a satellite.

A satellite radio access network, which is part of the NTN (or satellite network), usually includes the following components:
A satellite that refers to a space-borne platform;
An earth-based gateway that connects the satellite to a base station or a core network, depending on the choice of architecture;
Feeder link that refers to the link between a gateway and a satellite; and/or
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes;
MEO: typical heights ranging from 5,000-25,000 km, with orbital periods ranging from 3-15 hours; and
GEO: height at about 35,786 km, with an orbital period of 24 hours.

Two basic architectures may be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the network node is located on the ground and the satellite forwards signals/data between the network node and the UE; and
Regenerative payload. The satellite includes on-board processing to demodulate and decode the received signal and regenerate the signal before sending it back to the earth. When applied to general 3GPP architecture and terminology, the regenerative payload architecture means that the network node is located in the satellite.

FIG. 1 shows an example architecture of a satellite network with bent pipe transponders (i.e., the transparent payload architecture).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive Internet of things (IoT) services with relaxed latency requirements, it may not even be necessary to support full earth-coverage. It may be sufficient to provide occasional or periodic coverage according to the orbital period of the constellation.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite may vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ¿=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | Distance | | One-way | | Propagation |
|---|---|---|---|---|---|---|
| Orbital | Elevation | UE <-> | | propagation | | delay |
| height | angle | satellite | | delay | | difference |
| 600 km | 90° | 600 | km | 2.0 | ms | — |
| | 30° | 1075 | km | 3.6 | ms | 1.6 ms |
| | 10° | 1932 | km | 6.4 | ms | 4.4 ms |
| 1200 km | 90° | 1200 | km | 4.0 | ms | — |
| | 30° | 1999 | km | 6.7 | ms | 2.7 ms |
| | 10° | 3131 | km | 10.4 | ms | 6.4 ms |
| 35786 km | 90° | 35786 | km | 119.4 | ms | — |
| | 30° | 38609 | km | 128.8 | ms | 9.4 ms |
| | 10° | 40581 | km | 135.4 | ms | 16.0 ms |

The propagation delay may also be highly variable due to the high velocity of the LEO and MEO satellites and change in the order of 10-100 μs every second, depending on the orbit altitude and satellite velocity.

Satellite ephemeris data is provided to the UE, for example, to assist with pointing a directional antenna (or an antenna beam) towards the satellite. A UE knowing its own position (e.g., from a global navigation satellite system (GNSS)), may also use the ephemeris data to calculate a correct timing relation and/or frequency drifts, e.g., Timing Advance (TA) and Doppler shift. The contents of the ephemeris data and the procedures on how to provide and update such data have not yet been studied in detail.

A satellite orbit may be typically described using 6 parameters. Exactly which set of parameters is used may be decided by the user; many different representations are possible. For example, a choice of parameters used often in astronomy is the set (α, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). The set of these parameters is illustrated in FIG. 2.

A two-line element (TLE) set is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes called orbital state vectors. They may be derived from the orbital elements and vice versa, since the information they contain is equivalent. All these formulations (and many others) are possible choices for the format of ephemeris data to be used in a NTN.

Additionally, the ephemeris data may be accompanied with information on possible coverage area, or timing information when the satellite is going to serve a certain geographical area on Earth.

### Terrestrial Network (TN)

A terrestrial network (TN) includes of one or more radio network nodes (e.g., base stations) deployed on the ground. The TN may also be called a non-NTN or non-satellite network. A UE operating in the TN is served by the radio network node belonging to the TN.

The TN is traditionally deployed using fixed base stations, which do not move. Therefore, the fixed BS is statically deployed in certain location within the coverage area. However, the TN may also include of one or more movable radio network nodes (e.g., mobile base stations such as drones, high altitude platform station (HAPS), etc.) which may move from one location to another.

### Multi-Carrier Operation

In multicarrier (MC) operation, the UE operates with at least two serving cells belonging to their respective serving carrier frequencies.

Examples of MC operations are carrier aggregation (CA), dual connectivity (DC), multi-connectivity (MuC), etc. The carrier frequency is also called a component carrier (CC), frequency layer, serving carrier, frequency channel, etc. Examples of serving cells are special cell (sPCell), secondary cell (SCell), etc. Examples of serving cells are special cell (sPCell), secondary cell (Scell), etc. Examples of SpCell are primary cell (Pcell), primary secondary cell (PSCell), etc. The carrier frequencies of SpCell, Scell, Pcell and PSCell are called a special CC (SpCC) or simply SpC, secondary CC (SCC), primary CC (PCC) and primary secondary CC (PSCC) or simply PSC respectively.

In CA, the UE is configured with one primary serving cell (called Pcell) and one or more secondary serving cells (Scells).

In DC, the UE is configured with a master cell group (MCG) which contains at least a Pcell and a secondary cell group (SCG) which contains at least a PSCell. Each of MCG and SCG may further contain one or more Scells. The Pcell manages (e.g., configures, changes, release, etc.) all Scells in MCG and PSCell in SCG. The PSCell manages all Scells in SCG. The cells in MCG and SCG may belong to the same radio access technology (RAT) (e.g., all cells are NR in both MCG and SCG like in NR-DC) or they may belong to different RATs (e.g., LTE cells in MCG and NR cells in SCG like in EN-DC or NR cells in MCG and LTE cells in SCG like in NE-DC).

NR CA and MR-DC (Multi-Radio Dual Connectivity, including NR-DC, EN-DC, and NE-DC) are examples of multi-carrier operation in NR.

### UE Measurements

The UE performs measurements on one or more downlink (DL) and/or uplink (UL) reference signal (RS) of one or more cells in different UE activity states, e.g., radio resource control (RRC) idle state, RRC inactive state, RRC connected state, etc. The measured cell may belong to or operate on the same carrier frequency as the serving cell (e.g., intra-frequency carrier) or it may belong to or operate on a different carrier frequency than the serving cell (e.g., non-serving carrier frequency). The non-serving carrier may be an inter-frequency carrier if the serving and measured cells belong to the same RAT but different carriers. The non-serving carrier may be called an inter-RAT carrier if the serving and measured cells belong to different RATs. Examples of downlink reference signals (RS) are channel state information reference signals (CSI-RS), cell-specific reference signals (CRS), demodulation reference signals (DMRS), primary synchronization signals (PSS), secondary synchronization signals (SSS), signals in synchronization signal/physical broadcast channel (SS/PBCH) block (SSB), discovery reference signals (DRS), positioning reference signals (PRS), etc. Examples of uplink RS are sounding reference signals (SRS), DMRS, etc.

Examples of measurements are cell identification (e.g., physical cell identifier (PCI) acquisition, PSS/SSS detection, cell detection, cell search, etc.), Reference Signal Received Power (RSRP), Reference Signal Received Quality (RSRQ), secondary synchronization RSRP (SS-RSRP), SS-RSRQ, signal to interference plus noise ratio (SINR), RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE receive-transmit (RX-TX) time difference measurement, Radio Link Monitoring (RLM), which consists of Out of Synchronization (out of sync) detection and In Synchronization (in-sync) detection, beam identifier or index (e.g., SSB index, CSI-RS index), etc.

The UE is typically configured by the network node via signalling (e.g., via RRC message) with measurement configuration and measurement reporting configuration, e.g., measurement gap pattern, carrier frequency information, types of measurements (e.g., RSRP, etc.), higher layer filtering coefficient, time to trigger report, reporting mechanism (e.g., periodic, event triggered reporting, event triggered periodic reporting, etc.), etc.

### Low Activity RRC State Multicarrier Measurements

The UE may be configured to perform low activity RRC state multicarrier (LAM) measurements to enable fast setup and configuration of the multicarrier operation (e.g., CA, DC, etc.) of the UE. LAM measurements refers to measurements performed by the UE during low RRC activity (e.g., during RRC idle, RRC inactive state, etc.). The LAM measurement is also called an early measurement reporting (EMR), idle/inactive multicarrier measurement, idle/inactive CA/DC measurement, etc. A LAM measurement may be a cell level measurement and/or a beam measurement which may be performed by the UE during the low activity RRC state.

A purpose of LAM measurement reporting mechanism is to enable a network node (e.g., serving cell) to receive the measurement results as soon as the UE moves to the RRC connected state. This allows the NW node to quickly configure the UE with multicarrier operation, e.g., with CA configuration and/or DC configuration (e.g., SCG setup).

The network node configures the UE in RRC connected state to perform LAM measurements on one or more carriers (e.g., LTE, NR, etc.) when the UE will be in low activity RRC state, e.g., RRC idle state, RRC inactive state. The UE starts a LAM timer (e.g., T331 timer) when the RRC connection is released, e.g., when the UE goes to idle or inactive state. The duration of the LAM timer (e.g., 50 seconds, etc.) is also part of the LAM measurement configuration message sent to the UE by the network node. The UE performs the LAM measurements when the LAM timer (e.g., T331 timer) is running. The UE may transition to the RRC connected state, e.g., before the LAM timer expires or shortly after the LAM timer expires. The network may request the UE to send the LAM measurement results, e.g., during RRC connection setup procedure.

### GNSS

A Global Navigation Satellite System includes a set of satellites orbiting the earth in orbits crossing each other, such that the orbits are distributed around the globe. The satellites transmit signals and data that allows a receiving device on earth to accurately determine time and frequency references and, maybe most importantly, accurately determine its position, provided that signals are received from a sufficient number of satellites (e.g., four). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System and the European Galileo.

The transmissions from GNSS satellites include signals that a receiving device uses to determine the distance to the satellite. By receiving such signals from multiple satellites, the device may determine its position. However, this requires that the device also knows the positions of the satellites. To enable this, the GNSS satellites also transmit data about their own orbits (from which position at a certain time may be derived). In GPS, such information is referred to as ephemeris data and almanac data (or sometimes lumped together under the term navigation information).

The time required to perform a GNSS measurement, e.g., GPS measurement, may vary widely, depending on the circumstances, mainly depending on the status of the ephemeris and almanac data the measuring device has previously acquired (if any). In the worst case, a GPS measurement may take several minutes. GPS is using a bit rate of 50 bps for transmitting its navigation information. The transmission of the GPS date, time and ephemeris information takes 90 seconds. Acquiring the GPS almanac containing orbital information for all satellites in the GPS constellation takes more than 10 minutes. If a UE already possesses this information the synchronization to the GPS signal for acquiring the UE position and Coordinated Universal Time (UTC) is a significantly faster procedure. Often, the time to perform a GNSS measurement is described in terms of three different states or starting type of the GNSS receiver:
Hot state: the device remembers its last calculated position and the satellites in view, the almanac used, and the UTC Time. It leverages this information to makes an attempt to lock onto the same satellites and calculate a new position. This is the quickest state but, generally, it only works close to the location of the last GNSS measurement.
Warm state: the device remembers its last calculated position, almanac used, and UTC Time, but not which satellites were in view. It then performs a reset and attempts to obtain the satellite signals and calculates a new position. The receiver has a general idea of which satellites to look for because it knows its last position and the almanac data helps identify which satellites are visible in the sky.
Cold state: the device does not have any usable previous information. The device attempts to locate satellites, download the almanac, and calculate the new location. This takes the longest time of all.
   In a hybrid network that includes both TN and NTN cells, the UE may be configured by the network node to perform measurements on TN and NTN cells. In low activity RRC state (e.g., RRC idle, RRC inactive states), according to the existing solution the UE served by a TN cell may perform a cell change (e.g., cell reselection) to one of the TN and NTN cells, whichever is better ranked, i.e., which has better received signal level (e.g., higher RSRP). However, this traditional cell change approach is not always appropriate for the UE which is served by the TN cell.
   One issue is that the UE may be configured by the serving TN cell to perform certain RN related procedures (e.g., idle/inactive state CA/DC measurements). These measurements may be lost if the UE always performs the cell change according to the traditional/existing cell change approach.
   Another issue is that the TN and NTN cells may be allocated different registration area. For instance, separate tracking areas are allocated to TN and NTN cells according to the 3GPP Technical Standard (TS) 23.501 v18.1.0 in order to enforce mobility restrictions. The cell change based on the traditional/existing procedure does not take into account these aspects and may lead to higher probability of paging loss.

### SUMMARY

Some embodiments advantageously provide methods and UEs for performing a cell change procedure in a hybrid terrestrial network-non terrestrial network (TN-NTN).

Some embodiments are applicable to the following scenario: a UE served by a first TN cell (Cell1) being configured by a network node to perform measurements on one or more cells of at least one TN carrier frequency and one or more cells of at least one NTN carrier frequency. In some embodiments, the UE may be configured by a network node to perform low activity multicarrier (LAM) measurements (e.g., idle/inactive state CA/DC measurements) on one or more cells of at least one TN carrier frequency. In some embodiments, the UE operates in low activity RRC state, e.g., in RRC idle state, RRC inactive state.

According to a first embodiment, the UE served by Cell1, determines whether the UE is configured to perform at least one LAM measurement, and performs the cell change from Cell1 to a second TN cell (Cell2) or to a third NTN cell (Cell3) based on whether the UE is configured to perform at least one LAM measurement. For example, if the UE is configured with the at least one LAM measurement, then the UE selects Cell2 as the new serving cell and performs the cell change (e.g., cell reselection) from Cell1 to Cell2. But if the UE is not configured to perform any LAM measurement, then the UE selects Cell2 or Cell3, whichever is better ranked (e.g., which has higher received signal level such as RSRP), as the new serving cell and performs the cell change (e.g., cell reselection) from Cell1 to the selected cell (Cell2 or Cell3). Both Cell2 and Cell3 may be qualified to become the new serving cell (e.g., after the cell change) based on one or more criteria or rules.

According to a second embodiment, the UE served by Cell1, determines whether Cell1 and a second TN cell (Cell2) are configured with or belong to the same registration area (RA) (e.g., tracking area code/ID, RAN area code/ID, etc.), and performs the cell change from Cell1 to a second TN cell (Cell2) or to a third NTN cell (Cell3) based on whether Cell1 and Cell3 are configured with or belong to the same RA. For example, if Cell1 and Cell2 are configured with or assigned the same/common RA, then the UE selects Cell2 as the new serving cell and performs the cell change (e.g., cell reselection) from Cell1 to Cell2. But if Cell1 and Cell2 are not configured with or not assigned the same/common RA, then the UE selects Cell2 or Cell3, whichever is better ranked (e.g., which has higher received signal level such as RSRP) as the new serving cell and performs the cell change (e.g., cell reselection) from Cell1 to the selected cell (Cell2 or Cell3). Both Cell2 and Cell3 qualified to become the new serving cell (e.g., after the cell change) based on one or more criteria or rules.

According to a third embodiment, the UE served by Cell1, determines the status of its own GNSS receiver or its last GNSS measurement; and performs the cell change from Cell1 to a second TN cell (Cell2) or to a third NTN cell (Cell3) based on the determined status of its own GNSS receiver or its last GNSS measurement. For example, the UE may perform the cell change to Cell2 if its GNSS receiver is in cold state and it does not have a valid GNSS measurement (both conditions), even if Cell3 is better ranked than Cell2. Otherwise, the UE may perform the cell change to Cell2 or Cell3, whichever one is better ranked when the UE's GNSS receiver is in hot state or has an existing valid GNSS measurement (either condition), i.e., its validity timer has not yet expired.

In some embodiments, under one or more conditions, the UE served by TN cell reselects a target TN cell (e.g., Cell2) even if Cell2 is weaker (lower signal quality such as RSRP) than a target NTN cell (e.g., Cell3) provided that both Cell2 and Cell3 are qualified as candidate the new serving cell. Examples of the conditions include the UE being configured by the network node (e.g., TN node) to perform the idle/inactive state CA/DC measurements, the current TN serving cell (Cell1) and the target/candidate TN cell (Cell2) belonging to or being assigned with the same registration area (e.g., same tracking area, same RAN area, etc.).
In some embodiments, a method ensures that the UE does not lose the LAM measurement (e.g., Idle/inactive state measurements) results and provides them to the network node when going to the RRC connected state;
In some embodiments, a method enables the network to setup multicarrier operation (e.g., CA and/or DC) in a shorter period of time since the LAM measurement results are not lost;
In some embodiments, the cell change delay (e.g., cell reselection delay) is reduced since the UE does not need to always perform registration area updates, e.g., TA update, RAN area update, etc.
In some embodiments, the loss of paging from the old or the new serving cell during the cell change delay (e.g., cell reselection delay) is minimized since the cell change delay is reduced.

According to one aspect, a method in a user equipment, UE, configured to communicate with a terrestrial network, TN, node and a non-terrestrial network, NTN, node, is provided. The method includes determining a qualification status of at least a first cell of a first TN node and a second cell of a first NTN node. The method includes selecting a target cell for a cell change, the target cell being one of a qualified first cell of the first TN node and a qualified second cell of the first NTN node, the target cell being selected based at least in part on at least one of: a low activity multicarrier, LAM, measurement capability of the UE; a registration area of a candidate target cell; and a state of a global navigation satellite system, GNSS, receiver of the user equipment. The method includes performing the cell change to the selected target cell.

According to this aspect, in some embodiments, when the UE is capable of LAM measurement, then selecting the qualified first cell as the target cell, and otherwise, selecting one of the qualified first cell and the qualified second cell as the target cell based at least in part on a comparison of received signal level measurements on each of the first and second cell. In some embodiments, the UE determines a capability to perform LAM measurements is based at least in part on an LAM measurement configuration received from a TN node of a current cell of the UE. In some embodiments, the LAM measurement configuration includes at least one of a frequency for performing an LAM measurement, a time duration for performing LAM measurements, a type of LAM measurement to be performed and a cell on which the LAM measurements are to be performed. In some embodiments, when a registration area of a current cell of the UE and a registration area of the qualified first cell are a same registration area, then selecting the qualified first cell as the target cell, and otherwise, selecting one of the qualified first cell and the qualified second cell as the target cell based at least in part on a comparison of received signal level measurements on each of the first and second cell. In some embodiments, a registration area of a cell is identified by a code broadcasted on a system information block, SIB. In some embodiments, when the qualified first cell and the qualified second cell are in a same registration area as the registration area of the current cell, then selecting one of the first cell and the second cell based on the comparison of received signal measurements on each of the first and second cell. In some embodiments, when the GNSS receiver is in a cold state and the UE does not have a current valid GNSS measurement, then selecting the qualified first cell as the target cell, and otherwise, selecting one of the qualified first cell and the qualified second cell as the target cell based at least in part on a comparison of received signal level measurements on each of the first and second cell. In some embodiments, a received signal level measurement is one of a reference signal received power, RSRP, measurement, a received signal strength, RSS, and a reference signal received quality, RSRQ. In some embodiments, determining a qualification status of a cell includes comparing the received signal level measurement on the cell to a threshold. In some embodiments, determining a qualification status of a cell includes comparing the received signal level measurement on the cell to a reference signal measurement on a current cell of the UE. In some embodiments, determining a qualification status of a cell includes comparing a received signal level of the first cell of the first TN node to a first threshold and comparing a received signal level of the second cell of the first NTN node to a second threshold. In some embodiments, determining a qualification status of a cell includes comparing a received signal level measurement on a cell to a threshold plus at least one variable offset. In some embodiments, the at least one variable offset is configured in a system information block, SIB, broadcasted on a current cell of the UE.

According to another aspect, a UE configured to communicate with a terrestrial network, TN, node and a non-terrestrial network, NTN, node, is provided. The UE is configured to determine a qualification status of at least a first cell of a first TN node and a second cell of a first NTN node. The UE is configured to select a target cell for a cell change, the target cell being one of a qualified first cell of the first TN node and a qualified second cell of the first NTN node, the target cell being selected based at least in part on at least one of: a low activity multicarrier, LAM, measurement capability of the UE; a registration area of a candidate target cell; and a state of a global navigation satellite system, GNSS, receiver of the user equipment. The UE is configured to perform the cell change to the selected target cell.

According to this aspect, in some embodiments, when the UE is capable of LAM measurement, then the UE is configured to select the qualified first cell as the target cell, and otherwise, select one of the qualified first cell and the qualified second cell as the target cell based at least in part on a comparison of received signal level measurements on each of the first and second cell. In some embodiments, the UE determines a capability to perform LAM measurements based at least in part on an LAM measurement configuration received from a TN node of a current cell of the UE. In some embodiments, the LAM measurement configuration includes at least one of a frequency for performing an LAM measurement, a time duration for performing LAM measurements, a type of LAM measurement to be performed and a cell on which the LAM measurements are to be performed. In some embodiments, when a registration area of a current cell of the UE and a registration area of the qualified first cell are a same registration area, then the UE is configured to select the qualified first cell as the target cell, and otherwise, select one of the qualified first cell and the qualified second cell as the target cell based at least in part on a comparison of received signal level measurements on each of the first and second cell. In some embodiments, a registration area of a cell is identified by a code broadcasted on a system information block, SIB. In some embodiments, when the qualified first cell and the qualified second cell are in a same registration area as the registration area of the current cell, then the UE is configured to select one of the first cell and the second cell based on the comparison of received signal measurements on each of the first and second cell. In some embodiments, when the GNSS receiver is in a cold state and the UE does not have a current valid GNSS measurement, then the UE is configured to select the qualified first cell as the target cell, and otherwise, select one of the qualified first cell and the qualified second cell as the target cell based at least in part on a comparison of received signal level measurements on each of the first and second cell. In some embodiments, a received signal level measurement is one of a reference signal received power, RSRP, measurement, a received signal strength, RSS, and a reference signal received quality, RSRQ. In some embodiments, determining a qualification status of a cell includes comparing the received signal level measurement on the cell to a threshold. In some embodiments, determining a qualification status of a cell includes comparing the received signal level measurement on the cell to a reference signal measurement on a current cell of the UE. In some embodiments, determining a qualification status of a cell includes comparing a received signal level of the first cell of the first TN node to a first threshold and comparing a received signal level of the second cell of the first NTN node to a second threshold. In some embodiments, determining a qualification status of a cell includes comparing a received signal level measurement on a cell to a threshold plus at least one variable offset. In some embodiments, the at least one variable offset is configured in a system information block, SIB, broadcasted on a current cell of the UE.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example architecture of a satellite network with bent pipe transponders;

FIG. 2 illustrates satellite orbital parameters;

FIG. 3 is a schematic diagram of an example network architecture illustrating a communication system connected via an intermediate network to a host computer according to the principles in the present disclosure;

FIG. 4 is a block diagram of a host computer communicating via a network node with a user equipment over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for performing a cell change procedure in a hybrid terrestrial network-non terrestrial network (TN-NTN);

FIG. 10 is a flowchart of an example process in a user equipment for performing a cell change procedure in a hybrid terrestrial network-non terrestrial network (TN-NTN);

FIG. 11 is a flowchart of another example process in a UE for performing a cell change in a hybrid TN-NTN according to principles disclosed herein; and

FIG. 12 illustrates an example TN-NTN architecture that enables cell change in a hybrid TN-NTN according to principles disclosed herein.

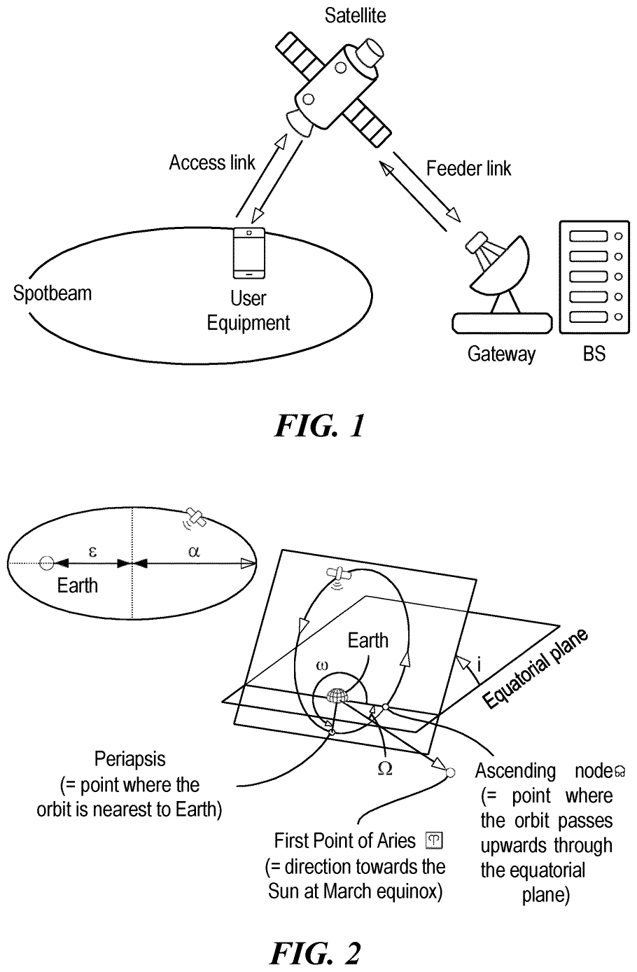

### DETAILED DESCRIPTION

Before describing in detail example embodiments, it is noted that the embodiments reside primarily in combinations of apparatus components and processing steps related to cell change procedure in a hybrid terrestrial network-non terrestrial network (TN-NTN). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “includes,” “including,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node included in a radio network which may further include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), O&M, OSS, self-organizing network (SON) node, a coordinating node, positioning node, MIDT node, etc.), a positioning node (e.g., E-SMLC), an external node (e.g., 3^{rd} party node, a node external to the current network), nodes in distributed antenna system (DAS), a spectrum access system (SAS) node, an element management system (EMS), etc. The network node may also include test equipment. The term “radio node” used herein may be used to also denote a user equipment (UE) or a wireless device (WD) or a radio network node.

In some embodiments, the non-limiting terms wireless device (WD) or a user equipment (UE) are used interchangeably. The UE herein may be any type of user equipment capable of communicating with a network node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may include any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH). The term “node” may also be used on its own, which may be a network node or a UE or wireless device (WD).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of user equipments and/or network nodes. In other words, it is contemplated that the functions of the network node and user equipment described herein are not limited to performance by a single physical device and, in fact, may be distributed among several physical devices.

The term carrier frequency used herein may refer to a component carrier (CC), frequency layer, layer, carrier, frequency, serving carrier, frequency channel, radio channel, radio frequency channel, positioning frequency layer (PFL), measurement object (MO), etc. The carrier frequency belongs to certain frequency band, which may contain one or multiple carrier frequencies based on its passband (e.g., size of the band in frequency domain) and/or bandwidth of the carriers and/or the channel raster, etc. The carrier frequency related information is transmitted to the UE 22 by a network node 16 using a frequency channel number or identifier via message, e.g., RRC. Examples of the channel number or identifier, which may be pre-defined, are absolute radio frequency channel number (ARFCN), NR-ARFCN, etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle, etc.

In this disclosure, the term Non-Terrestrial Network (NTN) may, depending on the context, refer to either or both of NR NTN and IoT NTN, and sometimes the term is used to refer to only NR NTN. Thus, even though the embodiments outlined below are described mainly in terms of NR based NTNs, they are equally applicable in an NTN based on LTE technology (and in particular IoT NTN).

The term radio access technology, or RAT, may refer to any RAT e.g., universal terrestrial access (UTRA), evolved UTRA (E-UTRA), narrow band internet of things (NB-IoT), WiFi, Bluetooth, next generation RAT, New Radio (NR), 4G, 5G, 6G, NR NTN, IoT NTN, LTE NTN, etc. Any of the equipment denoted by the term node, network node or radio network node may be capable of supporting a single or multiple RATs.

The term signal or radio signal used herein may be any physical signal or physical channel. Examples of DL physical signals are reference signal (RS) such as cell specific RS (CRS), NR-IoT RS (NRS), NPSS, NSSS, PSS, SSS, CSI-RS, DMRS signals in SS/PBCH block (SSB), discovery reference signal (DRS), CRS, PRS, etc. RS may be periodic, e.g., RS occasion carrying one or more RSs may occur with certain periodicity, e.g., 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity, e.g., 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration including parameters such as SMTC periodicity, SMTC occasion length in time or duration, SMTC time offset with respect to a reference time (e.g., serving cell's SFN), etc. Therefore, SMTC occasion may also occur with certain periodicity, e.g., 5 ms, 10 ms, 20 ms, 40 ms, 80 ms and 160 ms. Examples of UL physical signals are reference signal such as SRS, DMRS, etc. The term physical channel refers to any channel carrying higher layer information, e.g., data, control, etc. Examples of physical channels are physical broadcast channel (PBCH), narrowband PBCH (NPBCH), physical downlink control channel (PDCCH), physical downlink shared channel (PDSCH), physical uplink control channel (sPUCCH), SPDSCH, sPUCCH, sPUSCH, MPDCCH, NPDCCH, NPDSCH, E-PDCCH, PUSCH, PUCCH, NPUSCH, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide cell change procedure in a hybrid terrestrial network-non terrestrial network (TN-NTN).

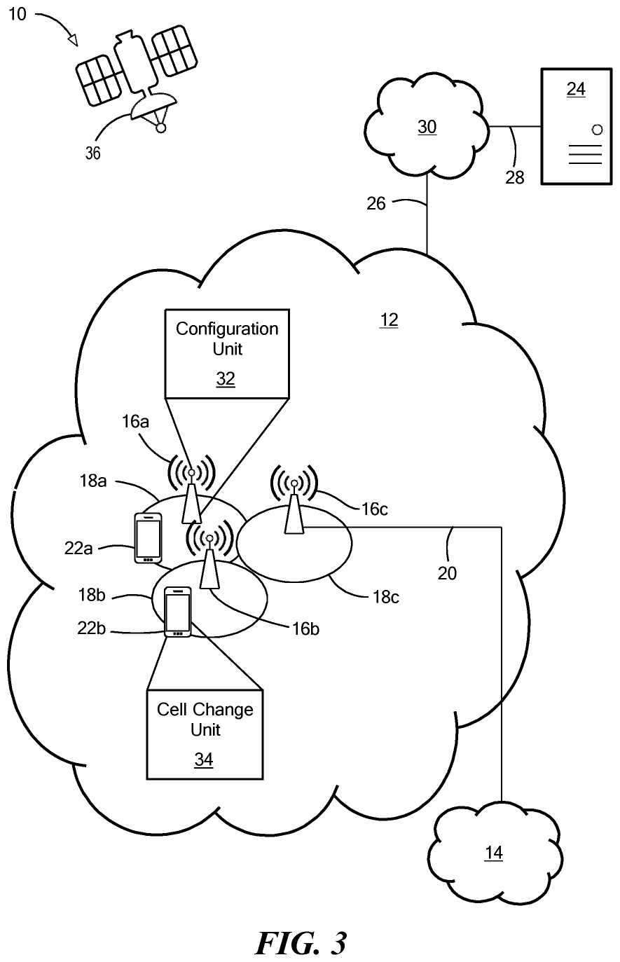

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which includes an access network 12, such as a radio access network, and a core network 14. The access network 12 includes a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as user equipments 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may include two or more sub-networks (not shown).

The communication system of FIG. 3 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a configuration unit 32 which may be configured to configure the UE 22 to perform at least one low activity measurement, LAM, on at least one carrier frequency. A user equipment 22 is configured to include a cell change unit 34 which may be configured to perform at least one low activity measurement, LAM, on at least one carrier frequency. The cell change unit 34 may be configured to determine a qualification status of at least a first cell of a first TN 16 node and a second cell of a first NTN node 36, and select a target cell for a cell change, the target cell being one of a qualified first cell of the first TN node 16 and a qualified second cell of the first NTN node 36. The communication system 10 may also include the non-terrestrial node 36 (for example, a communications satellite), that is in wireless communication with a network node 16 and/or a UE 22.

Example implementations, in accordance with an embodiment, of the UE 22, network node 16 and host computer 24 discussed in the preceding paragraphs will now be described with reference to FIG. 2. In a communication system 10, a host computer 24 includes hardware (HW) 38 including a communication interface 40 configured to set up and maintain a wired or wireless connection with an interface of a different communication device of the communication system 10. The host computer 24 further includes processing circuitry 42, which may have storage and/or processing capabilities. The processing circuitry 42 may include a processor 44 and memory 46. In particular, in addition to or instead of a processor, such as a central processing unit, and memory, the processing circuitry 42 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the user equipment 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which may be configured to configure the UE 22 to perform at least one low activity measurement, LAM, on at least one carrier frequency.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers. For example, the radio interface 82 may include a global navigation satellite system (GNSS) receiver.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further include software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the user equipment 22 may include a cell change unit 34 which may be configured to perform at least one low activity measurement, LAM, on at least one carrier frequency. The cell change unit 34 may be configured to determine a qualification status of at least a first cell of a first TN node and a second cell of a first NTN node, and select a target cell for a cell change, the target cell being one of a qualified first cell of the first TN node and a qualified second cell of the first NTN node.

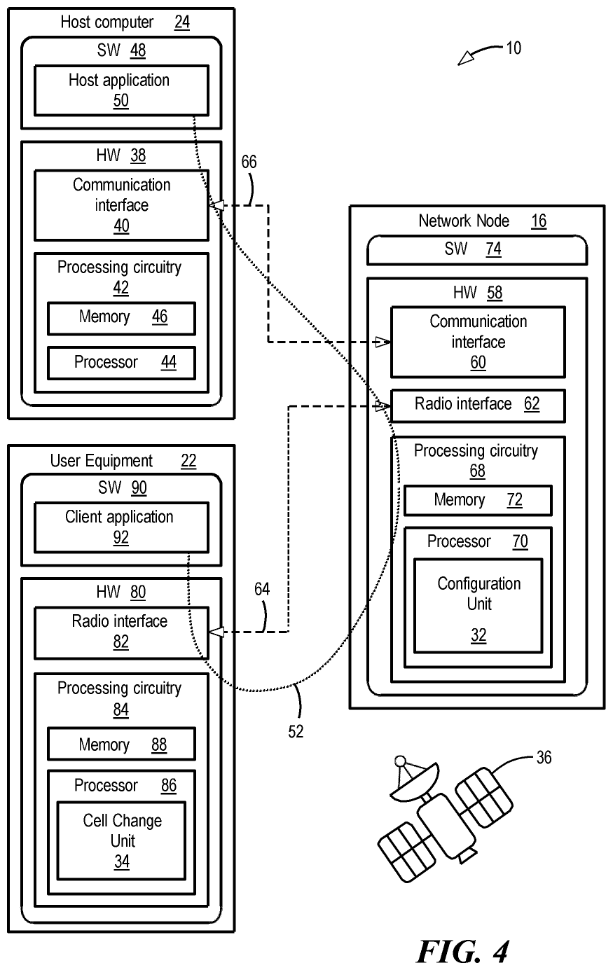

In some embodiments, the inner workings of the network node 16, UE 22, and host computer 24 may be as shown in FIG. 4 and independently, the surrounding network topology may be that of FIG. 3.

In FIG. 2, the OTT connection 52 has been drawn abstractly to illustrate the communication between the host computer 24 and the user equipment 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing, etc.; the reconfiguring need not affect the network node 16, and it may be unknown or imperceptible to the network node 16.

Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or includes a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as xxx unit 32, and xxx unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

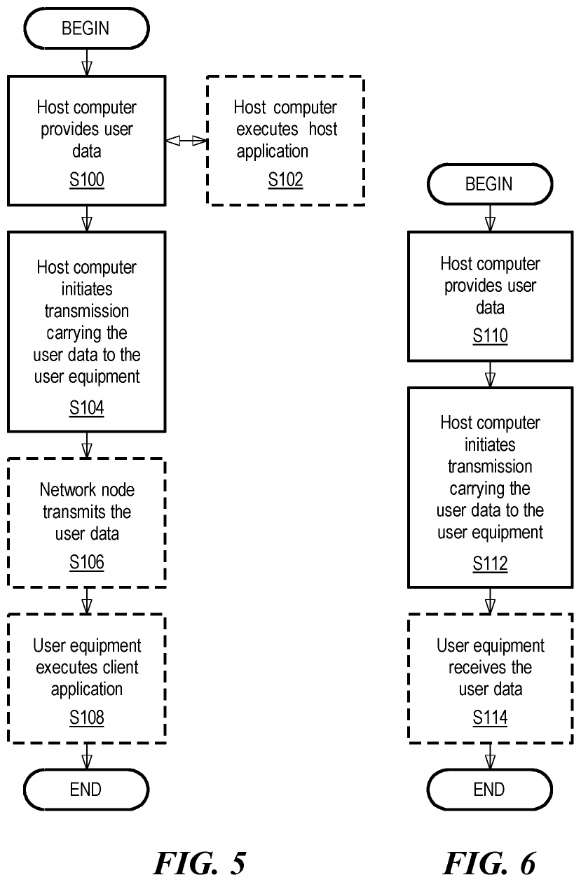

FIG. 5 is a flowchart illustrating an example method implemented in a communication system, such as, for example, the communication system of FIGS. 3 and 4, in accordance with one embodiment. The communication system may include a host computer 24, a network node 16 and a UE 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

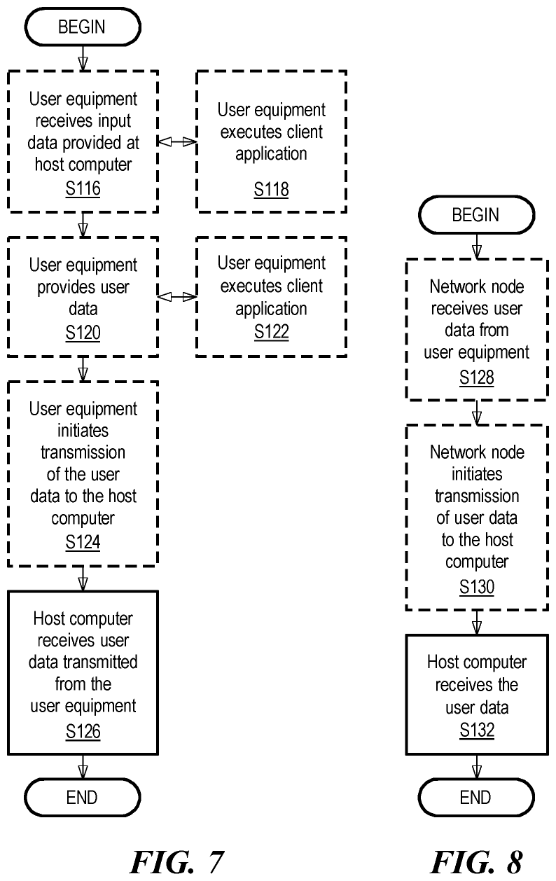

FIG. 7 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

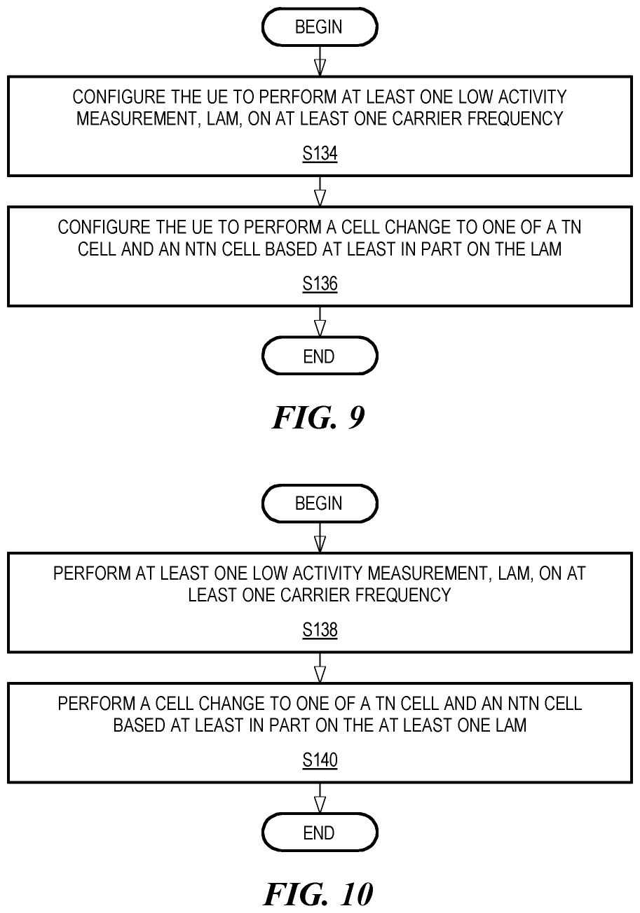

FIG. 9 is a flowchart of an example process in a network node 16 for performing a cell change procedure in a hybrid terrestrial network-non terrestrial network (TN-NTN). One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the UE 22 to perform at least one low activity measurement, LAM, on at least one carrier frequency (Block S134). The process also includes configuring the UE 22 to perform a cell change to one of a TN cell and an NTN cell based at least in part on the LAM (Block S136).

In some embodiments, the method includes determining when the TN cell and the NTN cell are qualified to act as a serving cell to serve the UE 22. In some embodiments, the method includes configuring the UE 22 to perform the LAM while the UE 22 is in a low activity radio resource control, RRC, state. In some embodiments, the method includes configuring the UE 22 to perform the LAM on at least one non-serving TN.

FIG. 10 is a flowchart of an example process in a user equipment 22 according to some embodiments of the present disclosure. One or more blocks described herein may be performed by one or more elements of user equipment 22 such as by one or more of processing circuitry 84 (including the cell change unit 34), processor 86, radio interface 82 and/or communication interface 60. Wireless device 22 such as via processing circuitry 84 and/or processor 86 and/or radio interface 82 is configured to perform at least one low activity measurement, LAM, on at least one carrier frequency (Block S138). The process includes performing a cell change to one of a TN cell and an NTN cell based at least in part on the at least one LAM (Block S140).

In some embodiments, performing the LAM is performed when the UE 22 is in a low activity radio resource control, RRC, state. In some embodiments, the method includes determining when the TN cell and the NTN cell are qualified to act as a serving cell to serve the UE 22. In some embodiments, the method includes configuring the UE 22 to perform the LAM on at least one non-serving TN. In some embodiments, the cell change is to the TN cell without regard to which of the TN cell and NTN cell provides higher received signal strength, RSL, to the UE 22. In some embodiments, the cell change is to the one of the TN cell and the NTN cell provides higher received signal strength, RSL, to the UE 22.

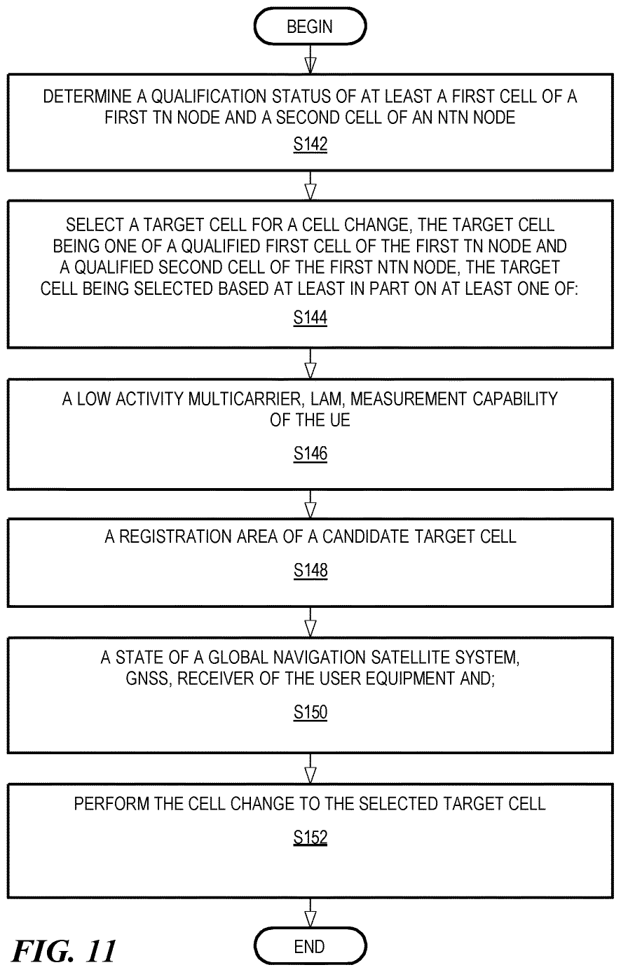

FIG. 11 is a flowchart of an example process in a user equipment 22 according to some embodiments of the present disclosure. One or more blocks described herein may be performed by one or more elements of user equipment 22 such as by one or more of processing circuitry 84 (including the change unit 34), processor 86, radio interface 82 and/or communication interface 60. Wireless device 22 such as via processing circuitry 84 and/or processor 86 and/or radio interface 82 is configured to determine a qualification status of at least a first cell of a first TN node 16 and a second cell of a first NTN node 36 (Block S142). The method includes selecting a target cell for a cell change, the target cell being one of a qualified first cell of the first TN node 16 and a qualified second cell of the first NTN node 36, the target cell being selected based at least in part on at least one of (Block S144): a low activity multicarrier, LAM, measurement capability of the UE (Block S146); a registration area of a candidate target cell (Block S148); and a state of a global navigation satellite system, GNSS, receiver of the user equipment (Block S150). The method includes performing the cell change to the selected target cell (Block S152).

According to this aspect, in some embodiments, when the UE 22 is capable of LAM measurement, then selecting the qualified first cell as the target cell, and otherwise, selecting one of the qualified first cell and the qualified second cell as the target cell based at least in part on a comparison of received signal level measurements on each of the first and second cell. In some embodiments, the UE 22 determines a capability to perform LAM measurements is based at least in part on an LAM measurement configuration received from a TN node 16 of a current cell of the UE 22. In some embodiments, the LAM measurement configuration includes at least one of a frequency for performing an LAM measurement, a time duration for performing LAM measurements, a type of LAM measurement to be performed and a cell on which the LAM measurements are to be performed. In some embodiments, when a registration area of a current cell of the UE 22 and a registration area of the qualified first cell are a same registration area, then selecting the qualified first cell as the target cell, and otherwise, selecting one of the qualified first cell and the qualified second cell as the target cell based at least in part on a comparison of received signal level measurements on each of the first and second cell. In some embodiments, a registration area of a cell is identified by a code broadcasted on a system information block, SIB. In some embodiments, when the qualified first cell and the qualified second cell are in a same registration area as the registration area of the current cell, then selecting one of the first cell and the second cell based on the comparison of received signal measurements on each of the first and second cell. In some embodiments, when the GNSS receiver is in a cold state and the UE 22 does not have a current valid GNSS measurement, then selecting the qualified first cell as the target cell, and otherwise, selecting one of the qualified first cell and the qualified second cell as the target cell based at least in part on a comparison of received signal level measurements on each of the first and second cell. In some embodiments, a received signal level measurement is one of a reference signal received power, RSRP, measurement, a received signal strength, RSS, and a reference signal received quality, RSRQ. In some embodiments, determining a qualification status of a cell includes comparing the received signal level measurement on the cell to a threshold. In some embodiments, determining a qualification status of a cell includes comparing the received signal level measurement on the cell to a reference signal measurement on a current cell of the UE 22. In some embodiments, determining a qualification status of a cell includes comparing a received signal level of the first cell of the first TN node 16 to a first threshold and comparing a received signal level of the second cell of the first NTN node 36 to a second threshold. In some embodiments, determining a qualification status of a cell includes comparing a received signal level measurement on a cell to a threshold plus at least one variable offset. In some embodiments, the at least one variable offset is configured in a system information block, SIB, broadcasted on a current cell of the UE 22.

Having described the general process flow of arrangements of the disclosure and having provided examples of hardware and software arrangements for implementing the processes and functions of the disclosure, the sections below provide details and examples of arrangements for performing a cell change procedure in a hybrid terrestrial network-non terrestrial network (TN-NTN).

### Terminology and Generalization

Further to the definitions provided above, the term “satellite” may also be called a satellite node 36, satellite access node (SAN) 36, a NTN node 36, node in the space, etc. A base station (BS) or radio network node (RNN), hereafter referred to as network node 16 or TN 16, associated with a satellite might include both a regenerative satellite, where the network node 16 is the satellite payload, i.e., the network node 16 is integrated with the satellite, or a transparent satellite, where the satellite payload is a relay and network node 16 is on the ground (i.e., the satellite relays the communication between the network node 16 on the ground and the UE 22).

### Some Embodiments

### Description of Scenario

One example scenario includes a UE 22 served by a first cell (Cell1), which is served or managed or operated by a first network node 16 (NW1 16). NW1 16 is an example of a TN node 16 (e.g., BS belonging to the TN) and Cell1 is a TN cell operating on a first TN carrier frequency (F11). The UE 22 is configured to perform measurements on at least F11 operated by or belonging to the TN and at least one carrier frequency (F21) operated by or belonging to the NTN node 36. F11 is an intra-frequency TN carrier. F21 may be inter-frequency or inter-RAT carrier frequency. F11 and F21 are deployed in separate Tracking Areas (TA). F21 is operated by an NTN node 36. An example of the NTN node 36 is a satellite node. A satellite node is also referred to herein as a satellite access node (SAN). As an example, a first SAN (SAN1) manages or serves or operates or controls one or more cells belonging to F21.

The UE 22 may further be configured to perform measurements on one or more non-serving TN carrier frequencies, e.g., on F12, which may be an inter-frequency or inter-RAT carrier frequency.

The UE 22 may also be configured by NW1 16 to perform one or more LAM measurements (e.g., RSRP, RSRQ, SSB index, etc.) on at least one TN carrier frequency (F13) while the UE 22 is in low activity RRC state, e.g., in RRC idle state, RRC inactive state, etc. F13 may be intra-frequency (e.g., same as F11), inter-frequency or inter-RAT carrier frequency. In one example, F11 and F13 are the same carrier frequencies or F13 and F12 are the same carrier frequencies. In another example, F13 is different than carrier frequencies, F11 and F12.

The UE 22 may operate in a low activity RRC state. In the low activity RRC state, the UE 22 may be configured with a discontinuous reception (DRX) cycle and may further be configured with an extended DRX (eDRX) cycle. Examples of low activity RRC state are RRC idle state, RRC inactive state, etc. An example of high activity RRC state is RRC connected state. In the high activity RRC state, the UE 22 may or may not be configured with DRX or eDRX cycles. In the low activity RRC state, the length of the configured DRX cycle is typically larger than a threshold, e.g., 320 ms or longer. In RRC idle state, the UE 22 receives paging from the core network node (e.g., access and mobility management function (AMF), mobility management entity (MME), etc.) via higher layer signaling, e.g., non-access stratum (NAS) signaling. In RRC inactive state, the UE 22 is known within radio access network (RAN) notification area (RNA). The RNA may include one or more cells which are assign the same RAN area code or identifier. In RRC inactive state, the UE 22 receives paging from the radio network node 16 (e.g., base station, etc.) via higher layer signaling, e.g., RRC signaling.

### Method in a UE of Adapting Cell Change Based on Ongoing LAM Measurements

In some embodiments, a UE 22 is served by a TN cell, a first cell (Cell1):
Determines that at least one TN cell, a second cell (Cell2) and at least one NTN cell, a third cell (Cell3), are qualified to become a new serving cell;
Determines whether the UE 22 is configured to perform at least one low activity multicarrier (LAM) measurement on at least one carrier frequency, F31; and
Performs the cell change according to the following rules:
   Performs the cell change to Cell2 upon determining that the UE 22 is configured to perform the at least one LAM measurement on F31 even if Cell3 is better ranked than Cell2; and/or
   Performs the cell change to Cell2 or Cell3, whichever one is better ranked, upon determining that the UE 22 is not configured to perform any LAM measurement on any carrier frequency.

The above steps are described below in detail with examples:

### Determining Target Cells for Performing Cell Change

In one step, the UE 22, which is served by a first TN cell (Cell1), may determine that at least one neighboring TN cell (Cell2) and at least one neighboring NTN cell (Cell3) are qualified to become a new serving cell. The ‘new serving cell’, which may also be called a candidate cell or potential serving cell, is different than the current serving cell, i.e., Cell1. Some embodiments are applicable for any number of TN and NTN cells which are qualified for becoming the new serving cell.

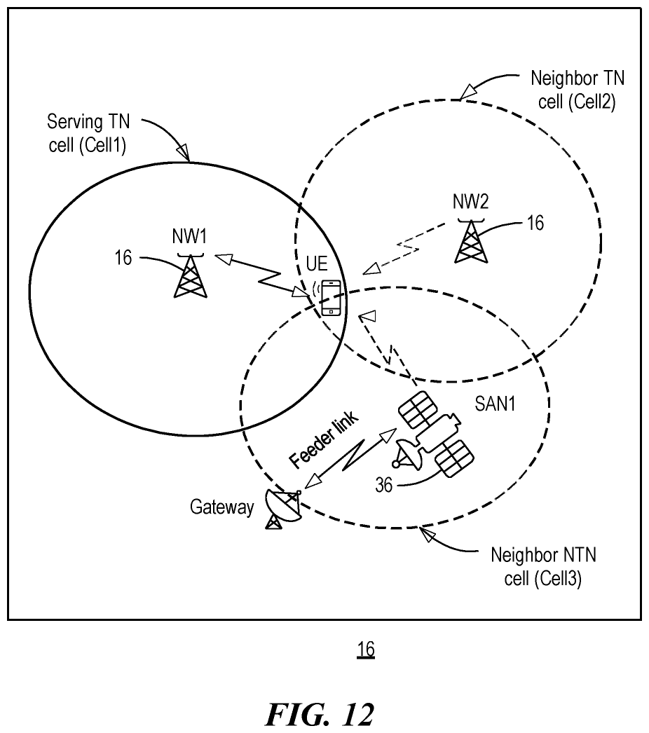

Cell1, which is a TN cell, operates on the carrier, F11. Cell2, which is also a TN cell and served by a TN node 16, a second network node (NW2 16), may operate on the carrier, F11 or on the carrier F12. In one example, NW1 16 and NW2 16 are different network nodes. In another example, NW1 16 and NW2 16 may be the same network node 16, e.g., F11 and F12 are operated by the same site/network node 16. Cell3 which is an NTN cell and served by a NTN node 36, a first SAN node (SAN1), operates on the carrier F21. This example is illustrated in FIGS. 12.

F11 and F12 may also be called TN carrier frequencies as they are operated by TN nodes 16 and F21 may also be called an NTN carrier frequency as it is operated by an NTN node 36, e.g., SAN. The UE 22 may determine whether a carrier frequency is TN or NTN based on one or more of the following:
By receiving an explicit indicator associated with a carrier frequency indicating whether that carrier frequency is TN or NTN, e.g., 1-bit indicator;
Based on channel number of the carrier frequency (e.g., ARFCN, NR-ARFCN). For example, the channel numbers of TN carriers and NTN carriers may be different and may be pre-defined. The channel number of a carrier configured for measurements may be signaled to the UE 22 by the network node 16, e.g., in a system information message;
Based on historical data or statistics. For example, a previously known carrier or previously measured carrier is again configured for the measurement, then the UE 22 assumes it is TN if it was TN earlier or NTN if it was NTN earlier;
By reading system information broadcasted by the serving cell or neighbor cell or receiving dedicated message sent by the serving cell of the UE 22. Parameters may include: carrier frequency, cell ID or satellite ID, etc., explicitly indicate carrier frequency or cell is TN or NTN; and/or

Based on information present in different system information blocks (e.g., SIB3, SIB4, SIB5, SIB19), the UE 22 may evaluate whether the cell is TN or NTN, based on the availability of satellite assistance information (e.g., ephemeris, common Timing Advance parameters, satellite ID, etc.) and its mapping to measurement assistance information (e.g., carrier frequency, PCI, etc.).

To determine whether one or more cells qualify to become a new serving cell, the UE 22 regularly searches and identifies cells and performs measurements (e.g., received signal level (RSL)) on the identified cells on one or more carrier frequencies. For example, in low activity RRC state, the UE 22 may be configured to search and measure the cells at least once every K1 number of discontinuous reception (DRX) cycles; where K1≥1. The one or more carrier frequencies may be configured by the serving cell (e.g., by Cell1) in a system information (SI) broadcasted to the UE 22, e.g., on one or more system information blocks (SIBs). Examples of the RSL are received signal strength (RSS), received signal quality (RSQ), etc. The RSL may be performed on the cell level (e.g., combining one or more beams) and/or on the beam level, i.e., measured on a beam. Examples of RSS are path loss, RSRP, etc. Examples of RSQ are reference signal received quality (RSRQ), signal to noise ratio (SNR), SINR, etc.

A cell, which may also be called a target cell or neighbor, may qualify to become a new serving cell if the UE 22 determines that the cell meets at least one of the following criteria or rules or conditions related to received signal level (RSL); otherwise that cell does not qualify to become a new serving cell:
1. In one example of the rule, the cell qualifies to become the new serving cell provided that the RSL of that cell measured by the UE 22 is larger than the measured RSL of Cell1 by certain threshold (H). In one example, the threshold (H) may be the same for the TN and NTN cells. In another example, the thresholds may be different for the TN and NTN cells. This is explained with examples below:
   a. For example, the TN cell (e.g., Cell2) qualifies to become the new serving cell provided that the following condition is met:

$$( {RSL}_{2} ) > ( {RSL}_{1} + {H}_{12} )$$

b. For example, the NTN cell (e.g., Cell3) qualifies to become the new serving cell provided that the following condition is met:

$${RSL}_{3} > ( {RSL}_{1} + {H}_{13} )$$

where:
   RSL₁, RSL₂ and RSL₃ are RSL measured by the UE 22 on signals (e.g., RS such as SSB, CSI-RS, etc.) of Cell1, Cell2 and Cell3 respectively; and
   H₁₂ and H₁₃ are thresholds, which may be pre-defined or configured by the network node 16, e.g., by NW1 16. In one example, H₁₂=H₁₃. In another example, H₁₂/H₁₃.
2. In another example of the rule, the cell qualifies to become the new serving cell provided that the RSL of that cell measured by the UE 22 is larger than certain threshold (G). In one example, the threshold (G) may be the same for the TN and NTN cells. In another example, the thresholds may be different for the TN and NTN cells. This is explained with examples below:
   a. For example, the TN cell (e.g., Cell2) may qualify to become the new serving cell provided that the following condition is met:

$${RSL}_{2} > {G}_{2}$$

b. For example, the NTN cell (e.g., Cell3) may qualify to become the new serving cell provided that the following condition is met:

$${RSL}_{3} > {G}_{3}$$

where:
   G₂ and G₃ are thresholds, which may be pre-defined or configured by the network node 16, e.g., by NW1 16. In one example, G₂=G₃. In another example, G₂≠G₃.
3. In another example, the cell qualifies to become the new serving cell provided that the sum of the RSL of that cell measured by the UE 22 and one or more margin values, is larger than the sum of the measured RSL of Cell1 and one or more margin values by a threshold (H). In one example, the threshold (H) may be the same for the TN and NTN cells. In another example, the thresholds may be different for the TN and NTN cells. This is explained with examples below:
   a. For example, the TN cell (e.g., Cell2) may qualify to become the new serving cell provided that the following condition is met:

$$( {RSL}_{2} + {α}_{21} + {α}_{22} ) > [ ( {RSL}_{1} + {α}_{11} + {α}_{12} ) + {H}_{12} ]$$

b. For example, the NTN cell (e.g., Cell3) may qualify to become the new serving cell provided that the following condition is met:

$$( {RSL}_{3} + {α}_{31} + {α}_{32} ) > [ ( {RSL}_{1} + {α}_{11} + {α}_{12} ) + {H}_{13} ]$$

where:
   α₁₁ and α₁₂ are margins, which may be positive or negative and are associated with Cell1. They are also called offset, temporary offset, hysteresis, etc. They may be configured by the broadcasting in system information, e.g., in a system information block (SIB). In some embodiments, α₁₁ is hysteresis value (e.g., +Q_{hyst}) and α₁₂ is a temporary offset value (e.g., −Q_{offsettemp}). In one example, α₁₁=0 and/or α₁₂=0.
   α₂₁ and α₂₂ are margins, which may be positive or negative and are associated with Cell2. They are also called offset, temporary offset, hysteresis, etc. They may be configured by the broadcasting in the system information, e.g., in a SIB. In some embodiments, α₂₁ is an offset value (e.g., −Q_{offset}) and α₂₂ is a temporary offset value (e.g., −Q_{offsettemp}). In one example, α₂₁=0 and/or α₂₂=0.
   α₃₁ and α₃₂ are margins, which may be positive or negative and are associated with Cell3. They are also called offset, temporary offset, hysteresis, etc. They may be configured by the broadcasting in the system information, e.g., in a SIB. In some embodiments, α₃₁ is an offset value (e.g., −Q_{offset}) and α₃₂ is a temporary offset value (e.g., −Q_{offsettemp}). In one example, α₃₁=0 and/or α₃₂=0.

FIG. 12 illustrates the UE 22 served by the TN cell (Cell1) and identifying one neighbor TN cell (Cell2) and one neighbor NTN cell (Cell3), which are candidates for performing a cell change (e.g., cell reselection).

### Determining LAM Measurement Configuration

In this step the UE 22 determines whether the UE 22 is configured to perform at least one low activity multicarrier (LAM) measurement on at least one carrier frequency, e.g., on the carrier F31.

Examples of the LAM measurements are measurements performed on one or more cells belong to or operating on one or more carrier frequencies (e.g., F31) configured for the LAM measurements, e.g., cell search/identification, RSL (e.g., RSS, RSRQ, etc.), beam index (e.g., SSB index, CSI-RS index, etc.).

The UE 22 may determine that the UE 22 is configured to perform at least one low activity measurement (LAM) on at least one carrier frequency provided that at least one of the following conditions or criteria is met; otherwise the UE 22 is not configured to perform any LAM measurement:
1. In some embodiments, the UE 22 may determine that it is configured to perform at least one LAM measurement provided that the UE 22 has received a message from the network node 16 (e.g., from Cell1 or from a previous serving cell) containing LAM configuration information. For example, the UE 22 may check this by retrieving the received message stored in the UE 22 memory. The received configuration information may include one or more of the following:
   a. Frequency information of the configured carrier(s) for performing the LAM measurement, e.g., ARFCN, NR-ARFCN, etc.;
   b. Time duration (e.g., value of the LAM timer such as T331) during which the LAM measurement(s) are to be performed;
   c. Type of LAM measurements to be performed, e.g., RSL (cell level and/or beam level), RS beam information (e.g., SSB index, etc.); and/or
   d. Cell information, e.g., identifiers (e.g., PCIs) of the cells on which the LAM measurements are to be performed;
2. In some embodiments, the UE 22 may determine that it is configured to perform at least one LAM provided that a LAM timer (e.g., timer T331) is running and there is not an ongoing small data transmission (SDT) procedure. The UE 22 performs the LAM at least while the LAM timer is running. The UE 22 starts the LAM timer when the UE 22 goes into low activity RRC state or if the UE 22 is configured to start the LAM timer at certain reference time (Tr). The Tr may be pre-defined or configured by the network node 16. The UE 22 may stop the LAM timer after the LAM timer duration (e.g., 120 seconds), which may be pre-defined or configured by the network node 16;
3. In some embodiments, the UE 22 may determine that it is configured to perform at least one LAM measurement provided that the UE 22 is currently performing at least one LAM measurement on at least one carrier frequency configured for the LAM measurement. Some UE 22 or a UE 22 in some scenario (e.g., has available/spare resources such as memory, processor, energy/power, etc.) may continue performing the at least one LAM measurement even after the LAM timer has expired, e.g., until the UE 22 moves to RRC connected state, over a certain duration, until the UE 22 has available resources for the LAM measurements, etc.; and/or
4. In some embodiments, the UE 22 may determine that it is configured to perform at least one LAM measurement provided that the UE 22 has at least one valid or reliable LAM measurement stored in its memory. In one example, the LAM measurement is considered as valid or reliable provided that the UE 22 has performed that LAM measurement during the last T11 time period with respect to the current time instance. Examples of T11 are X11 seconds, X12 number of DRX cycles, X13 number of RS periodicities (e.g., SMTC periods, etc.), etc.

### Adaptively Performing Cell Change

In this step the UE 22 performs the cell change (e.g., cell reselection from Cell1) to one of the target/neighbor cells (Cell2 or Cell3), which are qualified to become a new serving cell according to the following rules:
The UE 22 may perform the cell change from Cell1 to Cell2 upon determining that the UE 22 is configured to perform the at least one LAM measurement (e.g., on F31) even if Cell3 is better ranked than Cell2; and/or.
The UE 22 may perform the cell change from Cell1 to Cell2 or Cell3 whichever one is better ranked upon determining that the UE 22 is not configured to perform any LAM measurement on any carrier frequency.

The cell change herein refers to any type of mobility procedure which enables the UE 22 to switch, change or modify its current (or old) serving cell with or by a new serving cell. As used herein, the serving cell may also be referred to as the target cell. Examples of the cell change procedures are cell reselection, RRC connection re-establishment, etc. After performing the cell change (e.g., cell reselection), the UE 22 is served by or camps on the new serving cell (e.g., Cell2 or Cell3).

The UE 22 determines the ranking of the cells (e.g., Cell2, Cell3, etc.) provided that they meet at least the cell selection criteria, which is evaluated by the UE 22 regularly, e.g., once every K2 number of the DRX cycles where K2≥1. In some embodiments, the cell selection criterion S for a cell is fulfilled when the following condition is met. Otherwise the cell selection criterion S for that cell is not fulfilled:

$$( Srxlev > 0 ) AND ( Squal > 0 )$$

where, Srxlev and Squal are function of at least received signal strength (RSS) and received signal quality (RSQ) measured on that cell respectively. The Srxlev and Squal for a cell are therefore derived or determined by the UE 22 based on at least the RSS (e.g., RSRP and RSQ (e.g., RSRQ) measurements respectively performed by the UE 22 on that cell.

The UE 22 may determine the ranking of the cells (e.g., Cell2, Cell3, etc.) according to one or more of the following rules:
1. In some embodiments, a cell (Cellx) has higher rank (or is better ranked) than the rank of another cell (Celly) provided that the RSL of the cell (Cellx) is larger than the RSL of the other cell (Celly); otherwise Celly has higher rank than that of Cellx. This is explained with examples below:
   a. For example, the TN cell (e.g., Cell2) has higher rank than the rank of the NTN cell (e.g., Cell3) provided that the following condition is met:

$${RSL}_{2} > {RSL}_{3}$$

b. For example, the NTN cell (e.g., Cell3) has higher rank than the rank of the TN cell (e.g., Cell2) provided that the following condition is met:

$${RSL}_{3} > {RSL}_{2}$$

where, RSL₁, RSL₂ and RSL₃ are the same as described above;
2. In some embodiments, a cell (Cellx) has higher rank (or is better ranked) than the rank of another cell (Celly) provided that the sum of, the RSL of the cell (Cellx) and one or more margin values, is larger than the sum of, the RSL of the other cell (Celly) and one or more margin values; otherwise Celly has higher rank than that of Cellx. This is explained with examples below:
   a. For example, the TN cell (e.g., Cell2) has higher rank than the rank of the NTN cell (e.g., Cell3) provided that the following condition is met:

$$( {RSL}_{2} + {α}_{21} + {α}_{22} ) > ( {RSL}_{3} + {α}_{31} + {α}_{32} )$$

b. For example, the NTN cell (e.g., Cell3) has higher rank than the rank of the TN cell (e.g., Cell2) provided that the following condition is met:

$$( {RSL}_{3} + {α}_{31} + {α}_{32} ) > ( {RSL}_{2} + {α}_{21} + {α}_{22} )$$

where, α₂₁, α₂₂, α₃₁ and α₃₂ are the same as described above.

### Method in a UE of Adapting Cell Change Based on Registration Area Relation

In some embodiments, a UE 22 served by a TN cell, a first cell (Cell1):
Determines that at least one TN cell, a second cell (Cell2), and at least one NTN cell, a third cell (Cell3), are qualified to become a new serving cell;
Determines whether Cell1 and Cell2 belong to the same or at least one common registration area (RA); and
Performs the cell change according to the following rules:
   Performs the cell change to Cell2 upon determining that Cell1 and Cell2 belong to the same or the common RA even if Cell3 is better ranked than Cell2; or
   Performs the cell change to Cell2 or Cell3, whichever one is better ranked, upon determining that Cell1 and Cell2 belong to different RA or do not have any common RA.

The above steps are described below in detail with examples.

### 1 Determining Target Cells for Performing Cell Change:

In this step, the UE 22 served by Cell1 determines that at least one neighboring TN cell (Cell2) and at least one neighboring NTN cell (Cell3) are qualified to become a new serving cell according to the same principles as described above.

### 2 Determining Relation Between Registration Areas of Cells:

In this step the UE 22 determines whether Cell1 and Cell2 belong to, or are configured with, the same or at least one common registration area (RA).

An RA may be designated by an identifier or a code, e.g., an integer such as 1, 2, 3, etc. Therefore, the RA information may include an RA identifier or a code. Examples of the RA are RAN notification area (RNA) and core network (CN) registration area (CRA), which is also called a tracking area (TA). RNA and CRA or TA are designated or identified by RAN area code/identifier and CRA or TA code/identifier, respectively. Cells in the RNA may be assigned the same RAN area code or identifier. Cells in the same TA may be assigned the same TA code or identifier.

The RA related IDs/codes (e.g., RAN area code, TA code, etc.) assigned to a cell may be transmitted by that cell in the broadcast system information (e.g., in a SIB). The UE 22 may determine the RA related code(s) of a cell by receiving or acquiring the system information (SI) of that cell. The UE 22 may acquire or read the SI of a target cell during cell selection and during the cell change (e.g., cell reselection) before the UE 22 selects that cell as the new serving cell. The UE 22 may also read the SI of the serving cell if the SI changes, e.g., indicated to the UE 22 in a paging message. In the UE 22, the non-access stratum (NAS) layer provides information to the access stratum (AS) layer to help determine the relationship between different elements of a RA.

Therefore, the UE 22 is aware of the RA related codes (e.g., RAN area code/ID, TA code/ID) of Cell1 since it is the serving cell. The UE 22 may acquire the SI of Cell2 and Cell3 to determine which one of these two cells should be selected as the new serving cells. Assume that Cell2 and Cell3 are qualified for becoming the new serving cell, as determined in a first step. Based on the acquired RA related codes assigned to Cell1 and Cell2, the UE 22 may determine the relation between their respective codes. The relation may indicate whether at least one RA code assigned to Cell1 and Cell2 are the same or they are different.

### 3 Adaptively Performing Cell Change:

In this step the UE 22 performs the cell change (e.g., cell reselection from Cell1) to one of the target/neighbor cells (Cell2 or Cell3), which are qualified to become a new serving cell according to the following rules:
Perform the cell change to Cell2 upon determining that Cell1 and Cell2 belong to the same or the common RA even if Cell3 is better ranked than Cell2; and/or
Perform the cell change to Cell2 or Cell3, whichever one is better ranked, upon determining that Cell1 and Cell2 belong to different RA or do not have any common RA.

The UE 22 may determine whether Cell1 and Cell2 are in the same or common RA based on any of the following rules:
In some embodiments, Cell1 and Cell2 belong to the same or the common RA provided that at least one RA code/identifier assigned to both cells is the same; otherwise Cell1 and Cell2 belong to different RAs. For example, assume that Cell1 and Cell2 are assigned the same TA code but different RAN area codes. In this case, it is assumed that Cell1 and Cell2 have the same or common RA. In this example, the UE 22 performs the cell change from Cell1 to Cell2 even if Cell3 is better ranked than Cell2; and/or
In some embodiments, Cell1 and Cell2 belong to the same or the common RA provided that all the RA codes/identifiers assigned to both cells are the same/common; otherwise Cell1 and Cell2 belong to different RAs. For example, assume that Cell1 and Cell2 are assigned the same TA code and also the same RAN area code. In this case, it is assumed that Cell1 and Cell2 have the same or common RA. In this example, the UE 22 performs the cell change from Cell1 to Cell2 even if Cell3 is better ranked than Cell2.

When the Cell1 and Cell2 do not have the same or common RA, then the UE 22 may perform the cell change from Cell1 to Cell2 or Cell3, whichever has been determined as the better ranked cell, among at least Cell2 and Cell3. The UE 22 may determine the cell ranking of Cell2 and Cell3 according to mechanisms and processes described herein.

### Method in a UE of Adapting Cell Change Based on Status of GNSS Receiver

In some embodiments, a UE 22 served by a TN cell, a first cell (Cell1):
Determines that at least one TN cell, a second cell (Cell2) and at least one NTN cell, a third cell (Cell3), are qualified to become a new serving cell;
Determines the status of its own GNSS receiver or its last GNSS measurement; and/or
Performs the cell change according to the following rules:
   Performs the cell change to Cell2 upon determining that its GNSS receiver is in cold state, and it does not have a valid GNSS measurement (both conditions), even if Cell3 is better ranked than Cell2; and/or
   Performs the cell change to Cell2 or Cell3, whichever one is better ranked, upon determining that the status of its GNSS receiver is hot or there is an existing valid GNSS measurement (either condition), i.e., its validity timer has not yet expired.

The above steps are described below in detail with examples.

### 4 Determining Target Cells for Performing Cell Change:

In this step, the UE 22 served by Cell1 may determine that at least one neighboring TN cell (Cell2) and at least one neighboring NTN cell (Cell3) are qualified to become a new serving cell according to the same principles as described in the first embodiment.

### 5 Determining the Status of GNSS Receiver or the Validity of a Previous GNSS Measurement:

In this step, the UE 22 may determine the status of its own GNSS receiver or the validity of an existing GNSS position measurement. As described herein, the GNSS receiver status influences the necessary time for a UE 22 to obtain an accurate GNSS position measurement which is required to access an NTN cell.

The status of UE's GNSS receiver may be assessed in two manners: by UE implementation, i.e., using proprietary algorithms specific to each receiver, or using specific field parameters or timers (e.g., at the RRC layer) that may or not be reported to network and are used to determine the time length required to obtain a new GNSS position measurement. The validity of an existing GNSS position measurement may be evaluated in a similar manner.

### 6 Adaptively Performing Cell Change:

In this step, the UE 22 may perform the cell change (e.g., cell reselection from Cell1) to one of the target/neighbor cells (Cell2 or Cell3), which are qualified to become a new serving cell according to the following rules:
Performs the cell change to Cell2 upon determining that the GNSS receiver is in cold state and there is not a valid GNSS position measurement even if Cell3 is better ranked than Cell2; and/or
Performs the cell change to Cell2 or Cell3, whichever one is better ranked, upon determining that the GNSS receiver is in hot state or there is an existing valid GNSS position measurement.

When the GNSS receiver is in cold state and there is not a valid GNSS position measurement, the UE 22 may perform the cell change from Cell1 to Cell2 or Cell3 whichever has been determined as the better ranked cell among at least Cell1 and Cell3. The UE 22 may determine the cell ranking of Cell2 and Cell3 according to the same mechanisms and procedures disclosed herein.

Some embodiments may include one or more of the following:
Embodiment A1. A network node configured to communicate with a wireless device (WD) in a terrestrial network, TN, and/or a non-terrestrial network, NTN, the network node configured to, and/or including a radio interface and/or including processing circuitry configured to:
configure the WD to perform at least one low activity multicarrier, LAM, measurement on at least one carrier frequency; and
configure the WD to perform a cell change to one of a TN cell and an NTN cell based at least in part on the LAM measurement.
Embodiment A2. The network node of Embodiment A1, wherein the network node, radio interface and/or processing circuitry are further configured to determine when the TN cell and the NTN cell are qualified to act as a serving cell to serve the WD.
Embodiment A3. The network node of any of Embodiments A1 and A2, wherein the network node, radio interface and/or processing circuitry are further configured to configure the WD to perform the LAM measurement while the WD is in a low activity radio resource control, RRC, state.
Embodiment A4. The network node of any of Embodiments A1-A3, wherein the network node, radio interface and/or processing circuitry are further configured to configure the WD to perform the LAM measurement on at least one non-serving TN.
Embodiment B1. A method implemented in a network node configured to communicate with a wireless device (WD) in a terrestrial network, TN, and/or a non-terrestrial network, NTN, the method including:
configuring the WD to perform at least one low activity multicarrier, LAM, measurement on at least one carrier frequency; and
configuring the WD to perform a cell change to one of a TN cell and an NTN cell based at least in part on the LAM measurement.
Embodiment B2. The method of Embodiment B1, further comprising determining when the TN cell and the NTN cell are qualified to act as a serving cell to serve the WD.
Embodiment B3. The method of any of Embodiments B1 and B2, further comprising configuring the WD to perform the LAM measurement while the WD is in a low activity radio resource control, RRC, state.
Embodiment B4. The method of any of Embodiments B1-B3, further comprising configuring the WD to perform the LAM measurement on at least one non-serving TN.
Embodiment C1. A wireless device (WD) configured to communicate with a network node, the WD configured to, and/or including a radio interface and/or processing circuitry configured to:
perform at least one low activity multicarrier, LAM, measurement on at least one carrier frequency; and
perform a cell change to one of a TN cell and an NTN cell based at least in part on the at least one LAM measurement.
Embodiment C2. The WD of Embodiment C1, wherein the LAM measurement is performed when the WD is in a low activity radio resource control, RRC, state.
Embodiment C3. The WD of any of Embodiments C1 and C2, wherein the network node, radio interface and/or processing circuitry are further configured to determine when the TN cell and the NTN cell are qualified to act as a serving cell to serve the WD.
Embodiment C4. The WD of any of Embodiments C1-C3, wherein the network node, radio interface and/or processing circuitry are further configured to configure the WD to perform the LAM measurement on at least one non-serving TN.
Embodiment C5. The WD of any of Embodiments C1-C4, wherein the cell change is to the TN cell without regard to which of the TN cell and NTN cell provides higher received signal strength, RSL, to the WD.
Embodiment C6. The WD of any of Embodiments C1-C4, wherein the cell change is to the one of the TN cell and the NTN cell provides higher received signal strength, RSL, to the WD.
Embodiment D1. A method in a wireless device (WD) configured to communicate with a network node, the method comprising:
performing at least one low activity multicarrier, LAM, measurement on at least one carrier frequency; and
performing a cell change to one of a TN cell and an NTN cell based at least in part on the at least one LAM measurement.
Embodiment D2. The method of Embodiment D1, wherein performing the LAM measurement is performed when the WD is in a low activity radio resource control, RRC, state.
Embodiment D3. The method of any of Embodiments D1 and D2, further comprising determining when the TN cell and the NTN cell are qualified to act as a serving cell to serve the WD.
Embodiment D4. The method of any of Embodiments D1-D3, further comprising configuring the WD to perform the LAM measurement on at least one non-serving TN.
Embodiment D5. The method of any of Embodiments D1-D4, wherein the cell change is to the TN cell without regard to which of the TN cell and NTN cell provides higher received signal strength, RSL, to the WD.
Embodiment D6. The method of any of Embodiments D1-D4, wherein the cell change is to the one of the TN cell and the NTN cell provides higher received signal strength, RSL, to the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| BS | Base Station |
| GEO | Geostationary Orbit |
| GNSS | Global Navigation Satellite System |
| HO | Handover |
| LEO | Low Earth Orbit |
| LTE | Long Term Evolution |
| MAC | Medium Access Control |
| NR | New Radio |
| NW | Network |
| NTN | Non-Terrestrial Network |
| RAT | Radio Access Technology |
| RRC | Radio Resource Control |
| RRM | Radio Resource Management |
| RS | Reference Signal |
| RSRP | Reference Signal Received Power |
| RSRQ | Reference Signal Received Quality |
| SAN | Satellite access node |
| SMTC | SSB Measurement Timing Configuration |
| SNR | Signal to noise ratio |
| TN | Terrestrial Network |
| UE | User Equipment |
| WD | Wireless device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a user equipment, UE, configured to communicate with a terrestrial network, TN, node and a non-terrestrial network, NTN, node, the method comprising:
selecting a target cell for a cell change, the target cell being a first cell of the first TN node and a second cell of the first NTN node, the target;
if the UE is configured to perform a low activity multicarrier, LAM, measurement with respect to the second cell, then selecting the first cell as the target cell, and otherwise, selecting one of the first cell and the second cell as the target cell based on a comparison of received signal level measurements on each of the first and second cell; and
performing the cell change to the selected target cell.

2. The method of claim 1, wherein, the UE performs the LAM measurement in a carrier of the second cell during low radio resource control, RRC, activity, and sends a LAN measurement result during or after RRC connected setup procedure.

3. The method of claim 1, wherein the UE determines a capability to perform LAM measurements based on a LAM measurement configuration received from a TN node of a current cell of the UE.

4. The method of claim 2, wherein the LAM measurement configuration includes at least one of a frequency for performing an LAM measurement, a time duration for performing LAM measurements, a type of LAM measurement to be performed and a cell on which the LAM measurements are to be performed.

5.-8. (canceled)

9. The method of claim 1, wherein the received signal level measurement is one of a reference signal received power, RSRP, measurement, a received signal strength, RSS, and a reference signal received quality, RSRQ.

10. The method of claim 1, wherein the first cell of the first TN node and the second cell of the first NTN node are determined as result of a qualification status determination process including comparing the received signal level measurement on the cell to a threshold.

11. The method of claim 10, wherein determining a qualification status of the cells includes comparing the received signal level measurement on the cell to a reference signal measurement on a current cell of the UE.

12. The method of claim 10, wherein determining a qualification status of the cells includes comparing a received signal level of the first cell of the first TN node to a first threshold and comparing a received signal level of the second cell of the first NTN node to a second threshold.

13. The method of claim 10, wherein determining a qualification status of a cell includes comparing a received signal level measurement on a cell to a threshold plus at least one variable offset.

14. The method of claim 13, wherein the at least one variable offset is configured in a system information block, SIB, broadcasted on a current cell of the UE.

15. A user equipment, UE, configured to communicate with a terrestrial network, TN, node and a non-terrestrial network, NTN, node, the UE configured to:
select a target cell for a cell change, the target cell being one of a first cell of the first TN node and a second cell of the first NTN node;
if the UE is configured to perform a low activity multicarrier, LAM, measurement with respect to the second cell, then selecting the first cell as the target cell, and otherwise, selecting one of the first cell and the second cell as the target cell based on a comparison of received signal level measurements on each of the first and second cell; and
perform the cell change to the selected target cell.

16. The UE of claim 15, wherein, the UE is configured to perform the LAM measurement in a carrier of the second cell during low radio resource control, RRC, activity, and to send a LAN measurement result during or after RRC connected setup procedure.

17. The UE of claim 15, wherein the UE determines a capability to perform LAM measurements based at least in part on an LAM measurement configuration received from a TN node of a current cell of the UE.

18. The UE of claim 15, wherein the LAM measurement configuration includes at least one of a frequency for performing an LAM measurement, a time duration for performing LAM measurements, a type of LAM measurement to be performed and a cell on which the LAM measurements are to be performed.

19.-22. (canceled)

23. The UE of claim 15, wherein a received signal level measurement is one of a reference signal received power, RSRP, measurement, a received signal strength, RSS, and a reference signal received quality, RSRQ.

24. The UE of claim 15, further configured to determine the first cell of the first TN node and the second cell of the first NTN node as result of a qualification status, wherein determining a qualification status of a cell includes comparing the received signal level measurement on the cell to a threshold.

25. The UE of claim 24, wherein determining the qualification status of the cell includes comparing the received signal level measurement on the cell to a reference signal measurement on a current cell of the UE.

26. The UE of claim 24, wherein determining the qualification status of the cell includes comparing a received signal level of the first cell of the first TN node to a first threshold and comparing a received signal level of the second cell of the first NTN node to a second threshold.

27. The UE of claim 24, wherein determining the qualification status of the cell includes comparing a received signal level measurement on a cell to a threshold plus at least one variable offset.

28. The UE of claim 27, wherein the at least one variable offset is configured in a system information block, SIB, broadcasted on a current cell of the UE.
